(19) United States
(12) Patent Application Publication
(10) Pub. No.: US 2025/0330071 A1
(43) Pub. Date: Oct. 23, 2025

(54) METHOD AND DEVICE FOR PRODUCING A WINDING MAT FOR A STATOR OR A ROTOR OF AN ELECTRIC MOTOR

(71) Applicant: ZF FRIEDRICHSHAFEN AG, Friedrichshafen (DE)

(72) Inventors: Matthias EBERT, Himmelstadt (DE); Ralf SCHNEIDER, Werneck (DE)

(21) Appl. No.: 18/863,544

(22) PCT Filed: May 11, 2023
(86) PCT No.: PCT/EP2023/062641

§ 371 Date: Nov. 6, 2024

(30) Foreign Application Priority Data
May 17, 2022 (DE) 10 2022 204 823.7

(51) Int. Cl. H02K 15/043

(52) U.S. Cl. CPC H02K 15/043; H02K 2215/00

(57) ABSTRACT

A method and device for producing a winding mat for a stator or rotor of an electric motor, in which two conductor strands are each fed to a respective receiving device along an X direction. Oppositely disposed winding heads are formed by a shaping tool and a layer step is stamped in the winding heads in the opposite sense in a Y direction. Bars that extend in a Z direction are formed by a movement of the receiving devices on a curved path, and a lifting movement of the receiving devices is carried out. The conductor strands are transferred to a conveying device and transported in X direction by one conveying cycle. The steps are repeated until a winding mat has been produced having a defined quantity of windings formed in each instance by the two conductor strands and in each instance comprise two winding heads and four bars.

### CROSS REFERENCE TO RELATED APPLICATIONS

This is a U.S. national stage of Application No. PCT/EP2023/062641 filed May 11, 2023. Priority is claimed on German Application No. DE 10 2022 204 823.7 filed May 17, 2022 the content of which is incorporated herein by reference.

### BACKGROUND OF THE INVENTION

### 1. Field of the Invention

The disclosure is directed to a method and a device for producing a winding mat for a stator or a rotor of an electric motor.

### 2. Description of the Related Art

The importance of electric motors has increased dramatically over the course of the transition to environmentally friendly energy and environmentally friendly mobility due to the rising demand for drives which are not dependent on fossil fuels. A conventional electric motor comprises a stator and a rotor. When current flows through the conductors wrapped around the rotor, a north pole and a south pole are formed and the rotor begins to rotate due to the external magnetic field of the stator. The type of winding for the stator and rotor plays an important role for the efficiency of the electric motor.

When winding the conductors to form a winding mat, which is fastened around or to the stator or rotor, the conductors are mechanically stressed. In order to ensure high efficiency, smooth running, a low noise level and high robustness of the electric motor, the winding process must be reproducible and cause the least possible mechanical stress on the conductors. Further, a high stress on the conductor material during winding is also disadvantageous in that it brings about an increased expenditure on material during production.

There are various methods for producing a winding mat for a stator or a rotor. In general, one or more winding wires or conductors, which can be round wires or flat wires, for example, are fed via a feed device to a winding blade or a plug-in board and wound around the latter.

Winding around a plug-in board is disclosed in WO2019/130232 A1. Conductors and a plug-in board are provided for this purpose. The latter has slots for receiving the conductors. The conductors are provided by one or more wire guide devices. The conductors are inserted into the slots of the plug-in board such that portions of the conductors lie inside of the slot and other portions of the conductors project beyond the slots. Connections (winding heads) to the portions (bars) of the conductors to be fitted in the next slot are formed in each instance from the portions of the conductors projecting beyond the slots.

A winding process for multiple winding around a winding blade is described in DE 10 2004 035 084 A1. A template is required for the winding process. Bars which comprise n parallel wires and are located on the template and winding heads which extend beyond the template are produced on the template in a first work step. The winding heads are preferably produced in a V- shape or a gable shape by shaping bodies mounted on the template. After the bars and winding heads have been produced, they are displaced along a rotational axis of the template in a second work step by n-times the intermediate spacing. The above-mentioned work steps are repeated until a quantity of windings has been produced which corresponds to a quantity of rotor slots or stator slots.

A method and a device for producing a distributed wave winding for electric motors, particularly one with a high pole number, are known from DE 197 39 353 A1. In the disclosed method, a coil group which comprises a plurality of wires or conductors and is associated with a first phase is produced in a wave-shaped manner on a rotatable template and transferred to an axially aligned coil receiver. The coil group is ejected for this purpose. A further coil group of the same phase with a switching connection to the previous coil group is subsequently wound and transferred to the same coil receiver. By the method, a plurality of wires can be processed in parallel without the individual wires intersecting.

A further winding method with a winding blade is described in U.S. Pat. No. 7,281,312 B2. The method is similar to the method described above but comprises, in addition, the transfer of the produced winding mat into a transfer tool, a rotor or a stator.

A substantial problem in the methods described above consists in the impossibility or economic infeasibility of adapting the dimensioning and transport (removal), especially with greater lengths of the winding mat, since the length of the template (plug-in board, winding blade, etc.) on which the wires or conductors are wound substantially corresponds to the length of the winding mat to be produced.

A method for producing a winding mat with a winding blade is also described in EP 3 182 568 B2 in which individual wires or a plurality of wires are wound multiple times around a winding blade. Holding elements may be provided that hold a portion of the wires during the winding, while another portion of the wires is moved relative to it. However, the winding is not carried out to the point that a quantity of windings is achieved that corresponds to the quantity of rotor slots or stator slots. Instead, the wound wires are removed directly after winding via a transporting device which rotates with a winding device and which is formed as a belt conveyor or toothed belt conveyor. This has the advantage that the length of the winding mat to be produced can be flexibly adapted to a stator or a rotor.

In the described winding methods, the conductors are removed from the winding blade or plug-in board after winding and are subsequently pressed flat together. Pressing the winding mat or conductors together places a very severe stress on the insulation of the conductors. Moreover, when a rotating plug-in board or winding blade is used, a change in pitch is only possible to a limited degree. As a result, the parallel-wound conductors may be asymmetric with respect to one another and circulating currents may form. This leads to losses in the conductors during operation and does not contribute to torque formation.

### SUMMARY OF THE INVENTION

It is an object of one aspect of the invention to provide a winding method for producing a winding mat for a stator or a rotor of an electric motor without the use of a winding blade to cause less mechanical stress on the conductors and allow a greater flexibility in configuring the winding mat.

One aspect of the invention is a method for producing a winding mat for a stator or a rotor of an electric motor in which two conductor strands with at least one conductor in each instance are provided, the conductor strands are fed, respectively, along the X direction to a receiving device which is connected to a guide and is movable in an X direction, a Y direction and a Z direction of a Cartesian coordinate system, one of the receiving devices in each instance receiving a conductor strand, oppositely disposed winding heads are formed, a first component of a shaping tool is fed in the opposite sense in a Z direction to each conductor strand, a first side of the winding head being formed in each instance, and a second component of the shaping tool is fed subsequently, a second side of the winding head being formed, and the winding heads are fixed in each instance in the shaping tools, a layer step is stamped in the opposite sense in the Y direction in a transition from the first side to the second side of the winding heads in each instance, bars extending in Z direction are formed, these bars being formed by a movement of the receiving devices on a curved path, a lifting movement of the receiving devices is executed in Y direction, wherein the conductor strands are transferred to a conveying device, and the conductor strands are transported by one conveying cycle in X direction, and the feed of the conductor strands, the forming of winding heads, the stamping of the layer steps, the forming of the bars, the execution of the lifting movement and the transporting of the conductor strands are repeated until a winding mat with a defined quantity of windings which are formed by the two conductor strands and comprise in each instance two winding heads and four bars has been produced.

The first side of the winding head and the second side of the winding head are formed in each instance for each conductor of the conductor strands.

In order to avoid stressing the conductor material, it makes sense to omit a plug-in board or a winding blade. This has the advantage that winding mats can be produced in virtually any length and shape with a comparatively small mat width and mat height, and conductors can be inserted and removed flexibly during the process.

The conductor strands advantageously have the same quantity of conductors and, in each instance, more than one conductor, and the feed of the conductor strands, the forming of winding heads, the stamping of the layer steps, the forming of the bars, the execution of the lifting movement and the transporting of the conductor strands are carried out, respectively, simultaneously for all of the conductors of the conductor strand.

The shaping tools can be exchanged during the process in order to vary a pitch of the windings within the winding mat which is produced. The pitch indicates the spacing between two adjacent bars of a conductor.

It is advantageous when the layer step is stamped in that the first component and the second component of the shaping tool are displaced relative to one another in Y direction. It is likewise advantageous when the layer step is stamped during the forming of the winding heads. The process can be accelerated in this way. The winding heads are advantageously gable-shaped.

To facilitate and accelerate the forming of the bars, a third component can deform the conductor strand in Z direction during the forming of the bars, the third component being moved in Z direction.

One aspect of the invention is a device for producing a winding mat for a stator or a rotor of an electric motor, which device comprises two receiving devices which are connected in each instance to a guide and are movable in an X direction, a Y direction and a Z direction of a Cartesian coordinate system, two shaping tools having in each instance a first component and a second component which can be displaced relative to one another in a Y direction of a Cartesian coordinate system, and a conveying device which is configured to transport the conductor strands in X direction by one conveying cycle.

The device is adapted to carry out the method for producing a winding mat for a stator or a rotor of an electric motor.

The guides can advantageously comprise in each instance a slide and rails on which the slide is guided. One of the guides is arranged above the conductor strands and the other guide is arranged below the conductor strands.

The receiving device can have a bending head with a wire holder and a bending bar.

It is advantageous when the shaping tools have in each instance a third component which is movable in Z direction.

### BRIEF DESCRIPTION OF THE DRAWINGS

The invention will be described in more detail in the following through embodiment examples referring to drawings. The drawings show:

FIG. 1 is a device for producing a winding mat;

FIGS. 2A-F are individual method steps for producing a winding mat in a top view;

FIG. 3 is a view of a receiving device;

FIG. 4 is a shaping tool; and

FIG. 5 is a diagram illustrating a stamping of a layer step with the shaping tool.

### DETAILED DESCRIPTION OF THE PRESENTLY PREFERRED EMBODIMENTS

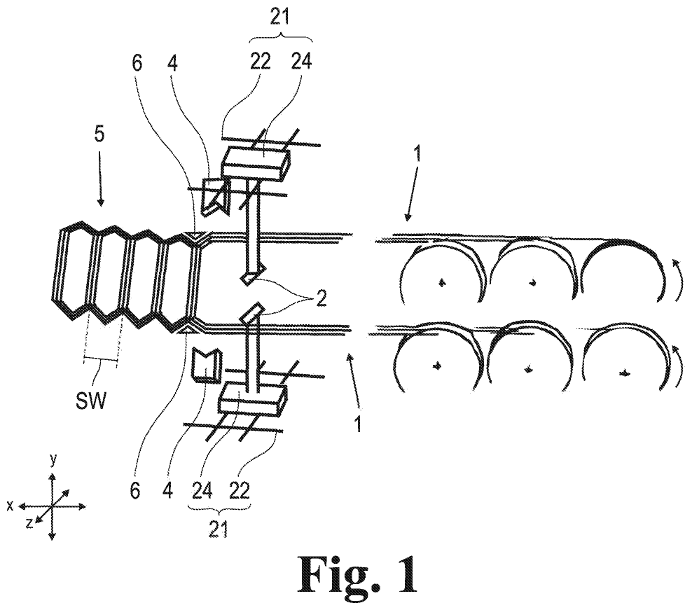

A view of a device for producing a winding mat 5 is shown in FIG. 1. The device has two receiving devices 2 connected in each instance to a guide 21 and are movable in an X direction, a Y direction and a Z direction of a Cartesian coordinate system. The guides 21 comprise in each instance a slide 24 and rails 22 on which the slide 24 is guided. One of the guides 21 is arranged above the conductor strands 1 so that one of the slides 24 is movable above the conductor strands 1 in a first plane parallel to an X-Z plane. The other guide 21 is arranged below the conductor strands 1 so that the other slide 24 is movable below the conductor strands 1 in a second plane which is parallel to the X-Z plane. Before being provided, the conductor strands 1 are wound onto reels. The conductor strands 1 are fed along the X direction of a Cartesian coordinate system to one of two receiving devices 2, respectively, in which the conductor strands 1 are received. The conductor strands 1 in each instance comprise at least one conductor, and the receiving devices 2 receive in each instance all of the conductors of a conductor strand 1. A conveying device 6 is arranged behind the receiving devices 2 in X direction considered from the reels. The conveying device 6 is configured to transport the conductor strands 1 in X direction by one conveying cycle.

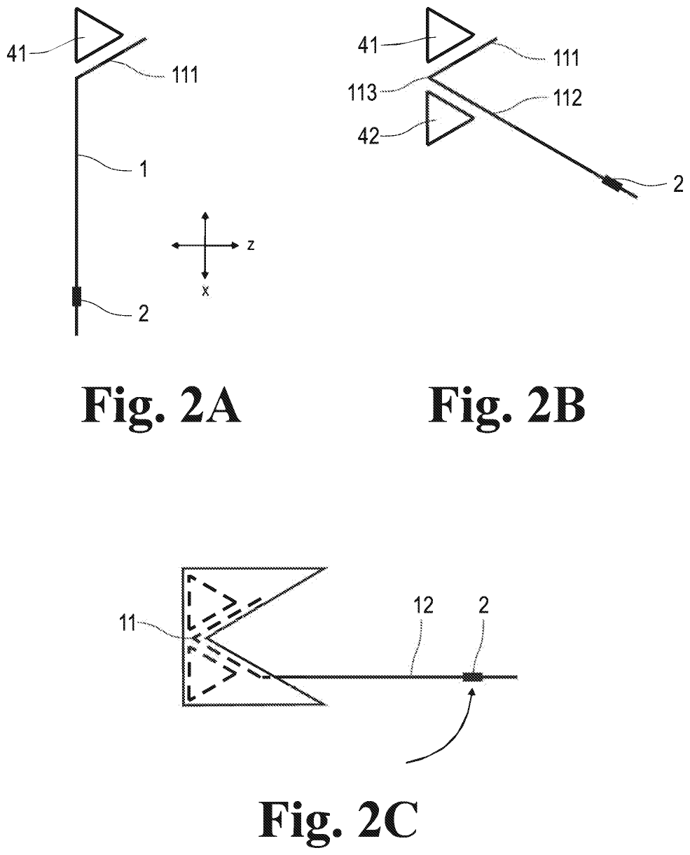

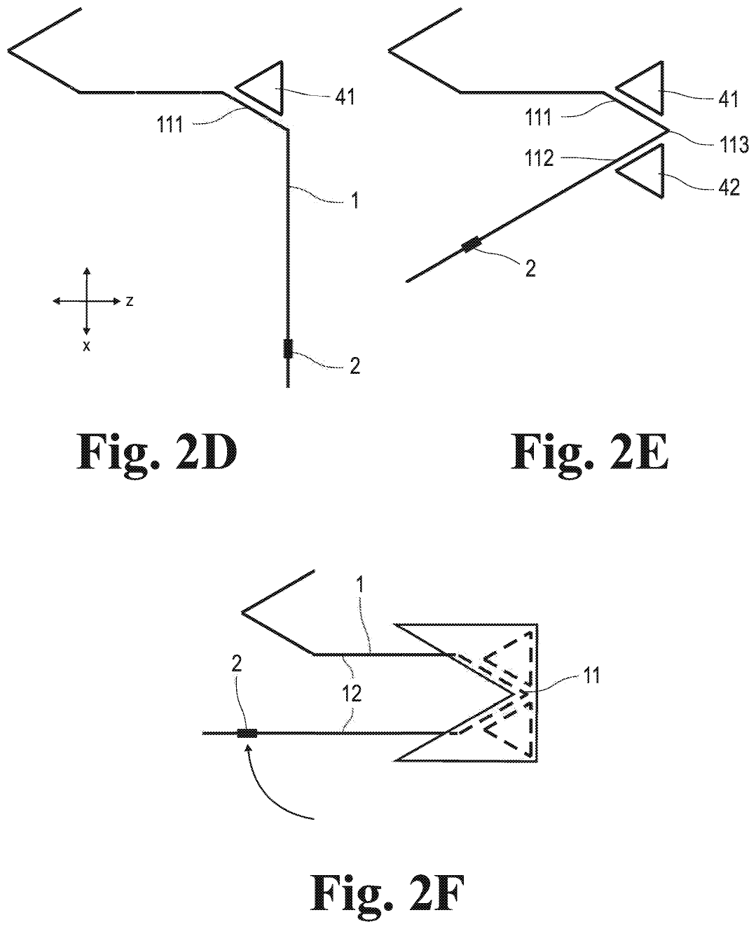

Individual method steps for the production of a winding mat 5 for a conductor strand 1 are illustrated in FIGS. 2a-f. The other conductor strand 1 is simultaneously wound in an analogous manner with oppositely disposed winding heads 11. In the method step shown in FIG. 2A, the conductor strand 1 is already received by the receiving device 2. A first component 41 of a shaping tool 4 is fed to the conductor strand 1 which is shown as an individual strand for purposes of clarity. The first component 41 is shown as an equilateral triangle for purposes of clarity. A first side 111 of a winding head 11 is formed by the feed. Subsequently, as is shown in FIG. 2B, a second component 42 of the shaping tool 4 is fed to the conductor strand 1. FIG. 2C shows the winding head 11 fixed in the shaping tool 4. As is shown in FIG. 2C, the winding head 11 is advantageously held by a plate, which is pressed against the first component 41, the second component 42 and the winding head 11 from above (opposite the Y direction). After fixing, the receiving device 2 executes a curving movement, as a result of which the conductor strand 1 is bent and a bar 12 is formed. After the winding head 11 and bar 12 are formed, a lifting movement of the receiving devices 2 is carried out in Y direction in order to transfer the conductor strands 1 to the conveying device 6. The conductor strand 1 is subsequently transported through the conveying device 6 in X direction by one conveying cycle which advantageously corresponds to a slot width of a stator or a rotor, and the above-mentioned method steps are repeated until a winding mat 5 has been produced which has a defined quantity of windings which are formed in each instance by the two conductor strands 1 and which comprise two winding heads 11 and four bars 12 in each instance. The bars 12 are associated in each instance with two windings except for the first bar 12 and last bar 12 of the winding mat 5. In FIGS. 2D-F, a next winding head 11 and a next bar 12 are formed. A further conductor strand 1 is formed (not shown) oppositely in parallel with the depicted method steps.

A pitch SW of the produced windings depends on the shaping tools 4 utilized in the winding process as does the shape of the winding heads 11. These shaping tools 4 can be exchanged over the course of the process, as a result of which the produced winding mat 5 can have windings with different pitches SW.

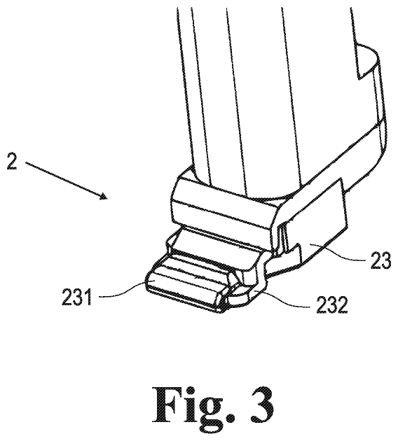

FIG. 3 shows an advantageous embodiment of the receiving device 2. The receiving device 2 has a bending head 23 with a wire holder 231 and a bending bar 232. One or more conductors of a conductor strand 1 can be received between the wire holder 231 and the bending bar 232. The conductor strands 1 should be mechanically stressed as little as possible as they are received in the receiving devices 2.

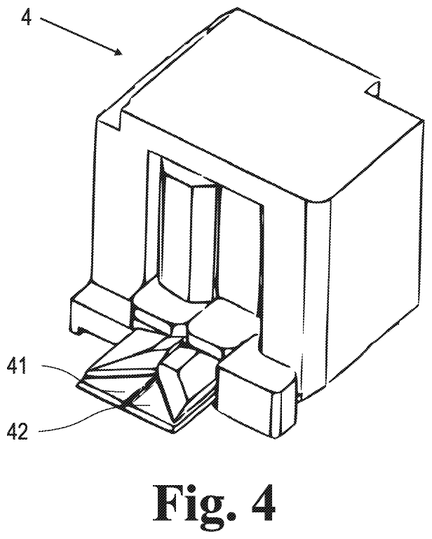

An advantageous embodiment of the shaping tool 4 is shown in FIG. 4. The shaping tool 4 advantageously has a first component 41 and a second component 42. The first component 41 and the second component 42 can have in each instance a linear drive and are movable relative to one another in Y direction. Also, it is possible that only the first component 41 or second component 42 is movable in Y direction.

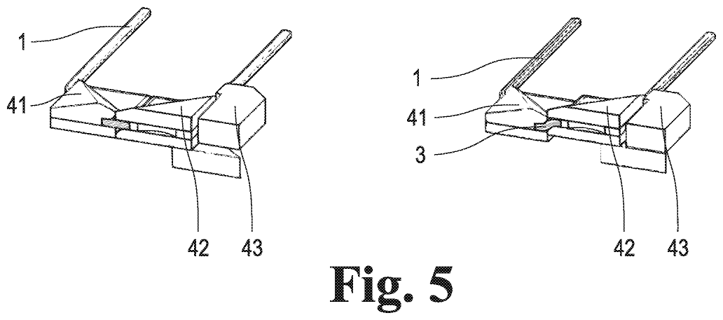

The stamping of a layer step 3 is shown in FIG. 5. The winding head 11 is fixed in the shaping tool 4 (not shown in its entirety). The layer step 3 can be stamped in a transition 113 from the first side 111 to the second side 112 by a movement of the first component 41 and second component 42 relative to one another in Y direction. The stamping can advantageously ensure in addition that the thickness of the conductor strand 1 or individual strands of the conductor strand 1 decreases. The stamping makes it possible to interweave a plurality of conductor strands 1 or windings with one another to form the winding mat 5.

FIG. 5 shows a third component 43 of the shaping tool 4 which is telescoping. The third component 43 can be moved to form the bars 12.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the 10 invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (Canceled)

10. A method for producing a winding mat for a stator or a rotor of an electric motor, comprising:
A. providing two conductor strands having at least one conductor in each instance;
B. feeding the two conductor strands to a respective receiving device along an X direction of a Cartesian coordinate system, each receiving device connected to a guide and is movable in an X direction, a Y direction, and a Z direction of a Cartesian coordinate system, wherein one of the receiving devices receives a conductor strand in each instance;
C. forming oppositely disposed winding heads, wherein a first component of a shaping tool is fed in an opposite sense in a Z direction to each conductor strand, wherein a first side of the winding head is formed in each instance, and a second component of the shaping tool is fed subsequently, wherein a second side of the winding head is formed, and the winding heads are fixed in each instance in the shaping tools;
D. stamping a layer step in the opposite sense in the Y direction in the first side or the second side or a transition from the first side to the second side of the winding heads, respectively;
E. forming bars extending in Z direction, wherein the bars are formed by a movement of the receiving devices on a curved path;
F. executing a lifting movement of the receiving devices in Y direction, wherein the conductor strands are transferred to a conveying device, and transporting the conductor strands by one conveying cycle in X direction; and
G. repeating B to F until a winding mat has been produced which has a defined quantity of windings which are formed by the two conductor strands and comprise in each instance two winding heads and four bars.

11. The method according to claim 10, wherein the two conductor strands have an identical quantity of conductors and, in each instance, more than one conductor, and B to F, respectively, are carried out simultaneously for all of the conductors of a conductor strand.

12. The method according to claim 10, wherein the shaping tools are exchanged during the method in order to vary a pitch of the windings.

13. The method according to claim 10, wherein the layer step is stamped in that the first component and the second component of the shaping tool are displaced relative to one another in Y direction.

14. The method according to claim 10, wherein a third component deforms the conductor strand in Z direction when the bars are formed, wherein the third component is moved in Z direction.

15. A device for producing a winding mat for a stator or a rotor of an electric motor, comprising:
two receiving devices which are connected in each instance to a guide and are movable in an X direction, a Y direction, and a Z direction of a Cartesian coordinate system;
two shaping tools having in each instance a first component and a second component that can be displaced relative to one another in a Y direction of a Cartesian coordinate system; and
a conveying device which is configured to transport conductor strands in X direction by one conveying cycle.

16. The device according to claim 15, wherein each guide comprise a slide and rails on which the slide is guided, wherein one of the guides is arranged above the conductor strands and the other guide is arranged below the conductor strands.

17. The device according to claim 15, wherein the receiving devices each have a bending head with a wire holder and a bending bar.

18. The device according to claim 15, wherein the shaping tools each have a third component which is movable in Z direction.
